(19) United States
(12) Patent Application Publication
(10) Pub. No.: US 2009/0147306 A1
(43) Pub. Date: Jun. 11, 2009

(54) PRINT SYSTEM, IMAGE-FORMING APPARATUS, AND INFORMATION-PROCESSING METHOD

(75) Inventor: Hideki Sugiyama, Kawasaki-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/326,774

(22) Filed: Dec. 2, 2008

(30) Foreign Application Priority Data
Dec. 5, 2007 (JP) 2007-314792
Oct. 24, 2008 (JP) 2008-274348

(51) Int. Cl. G06F 3/12

(52) U.S. Cl. 358/1.15

(57) ABSTRACT

Administration such as the administration of the upper limit of a user is performed in an administration server, so as to control printing for each user, and data of a permission list is updated in a printer, so as to perform communication control and interrupt a communication performed for a client apparatus after the job execution.

### BACKGROUND OF THE INVENTION

1. Field of the Invention

The present invention relates to a print system provided to reduce invalid printing.

2. Description of the Related Art

In recent years, image-forming apparatuses including copiers, printers, and so forth have become widely available in the offices of companies, for example, which make it easy for anyone to copy and print data. However, problems including a security problem such as the leakage of printed matter including in-house documents, unnecessary printing, abandoned printing output by unknown users, and so forth have occurred.

For solving the above-described problems, there have been print-administration systems summarizing information relating to processing such as printing for each user, the information indicating the printed-document name, the date and time of printing, sheets, the number of copies, color/monochrome, and so forth. Further, there has been the following technology achieved through the print-administration system. Namely, the number of printable sheets is determined for each user, and if it is determined that the number of printed sheets exceeds the determined printable sheet number based on the print history (log) of which data is summarized through an application at the time when a client apparatus transmits a print instruction to an image-forming apparatus, the printing is restricted.

Further, additional information which is not usually added by a print application and/or a printer driver (e.g., customer information, the unit price of printing, charging-destination information, and so forth) is associated and added to a print job by using a special application through the client apparatus or the like. Then, the additional information is incorporated into the print-history data and administered.

As a method of associating the additional information with a print job transmitted from the client apparatus to the image-forming apparatus, there has been the method of inputting the additional information through a print-setting-dialogue image at the job-generation time and writing the additional information in an area different from an area in which print information is stored (e.g., a header) through a printer driver. Further, in practice, the additional information and the print job are associated with each other before the print job is transmitted to the image-forming apparatus, and transmitted independently of each other.

According to Japanese Patent Laid-Open No. 2000-035871, a print server includes data of a permission list and reads data of the name of a client apparatus, the data being included in a print job generated by the client apparatus. If the name is not shown on the permission list of the print server, the print server prohibits printing performed based on the print job. Consequently, it becomes possible to reduce printing performed by a client apparatus other than permitted client apparatuses without transmitting the print job to the image-forming apparatus.

According to Japanese Patent Laid-Open No. 2004-168069, a printer includes data of a print-permission list, and adds and/or deletes data of a network address to and/or from the print-permission list based on a maintenance message transmitted from a maintenance computer. Upon receiving print data and a print request, the printer performs printing when the network address of the transmission source of the print request is shown on the print-permission list. Otherwise, the printer transmits data of a message indicating that the printing is not permitted to the transmission source and does not perform the printing.

According to Japanese Patent Laid-Open No. 2000-035871, the determination of the print permission is performed not in the client apparatus, but in the print server. According to the above-described configuration, the client apparatus should transmit at least a packet relating to the print request to the print server.

Further, according to Japanese Patent Laid-Open No. 2004-168069, the printer is configured to maintain the print-permission-list data, as static information. Further, the network address of a client apparatus is registered with the print-permission list of the printer and whether printing should be permitted or not is determined for each apparatus. If a single client apparatus is used by a plurality of users in the above-described circumstance, further technical ideas are desired, so as to perform print control such as the administration of the upper limit of the printing number determined for each user.

### SUMMARY OF THE INVENTION

Accordingly, the present invention provides a contrivance to control giving and/or not giving the print permission to each job while performing the print control for each user. The present invention further provides a contrivance to perform control so that an image-forming apparatus does not receive print data generated based on an invalid print request transmitted from a client apparatus.

Accordingly, a print system according to an aspect of the present invention is a print system including a client apparatus generating a job, an image-forming apparatus performing print processing based on a job transmitted from the client apparatus, and an administration apparatus controlling the print processing. The client apparatus includes a job-generation unit configured to generate the job based on an instruction transmitted from a user, a permission-application-generation unit configured to generate permission-application data including job-identification information provided to identify the generated job, client-identification information provided to identify the client apparatus, and user-identification information provided to identify the user, so as to apply for permission to execute the job in the image-forming apparatus, a permission-application-transmission unit configured to transmit the generated permission-application data to the administration apparatus, and a job-transmission unit configured to transmit the generated job to the image-forming apparatus. The administration apparatus includes a permission-application-reception unit configured to receive the permission-application data transmitted from the client apparatus, a user list provided to manage user-identification information provided to identify a user permitted to print data through the image-forming apparatus, a permission-command-generation unit configured to generate a permission command provided to permit printing corresponding to the permission-application data, the permission command including the job-identification information and the client-identification information, based on a fact that the user-identification information included in the permission-application data is managed on the user list, and a permission-command-transmission unit configured to transmit the generated permission command to the image-forming apparatus. The image-forming apparatus includes a permission-command-reception unit configured to receive a permission command transmitted from the administration apparatus, a permission list provided to manage client-identification information provided to identify a client apparatus permitted to perform processing for the job, a registration unit configured to register the client-identification information and the job-identification information with the permission list in association with each other, where the client-identification information and the job-identification information are included in the permission command received by the permission-command-reception unit, a job-reception unit configured to receive the job transmitted from the client apparatus identified by the client-identification information managed on the permission list, a print unit configured to execute print processing based on the job received by the job-reception unit, and a permission-cancellation unit configured to delete the job-identification information of the job and the client-identification information managed in correspondence with the job-identification information that are shown on the permission list after the print unit executes the print processing based on the job.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the present invention and, together with the description, serve to explain the principles of the present invention.

FIG. 1 shows an exemplary configuration of a print system according to an embodiment of the present invention.

FIG. 2 is a block diagram showing an exemplary detailed configuration of each of a client apparatus and an image-forming apparatus according to an embodiment of the present invention.

FIG. 3 shows an exemplary information-input-screen image according to an embodiment of the present invention.

FIG. 4 is a diagram showing the module configuration of a print system according to an embodiment of the present invention.

FIG. 5 is a flowchart showing processing operations performed in an image-forming apparatus according to a first embodiment of the present invention.

FIG. 6 shows an exemplary communication packet according to the first embodiment.

FIG. 7 shows an exemplary permission list maintained by the image-forming apparatus of the first embodiment.

FIG. 8 is a flowchart showing processing operations performed in a spooler-monitoring module according to the first embodiment.

FIG. 9 is a flowchart showing processing operations performed on an information-input UI according to the first embodiment.

FIG. 10 shows an exemplary permission list maintained by a client-administration module of an administration server according to the first embodiment.

FIG. 11 is a flowchart showing processing operations performed in a print-permission-application module according to the first embodiment.

FIG. 12 is a flowchart showing processing operations performed in the client-administration module of the first embodiment.

FIG. 13 is a flowchart showing processing operations performed to cancel the print permission by an image-forming apparatus according to a second embodiment of the present invention.

FIG. 14 is a flowchart showing processing operations performed to cancel the print permission by an image-forming apparatus according to a third embodiment of the present invention.

FIG. 15 is a flowchart showing processing operations performed by an image-forming apparatus according to a fourth embodiment of the present invention.

FIG. 16 is a flowchart showing processing operations performed by an image-forming apparatus according to a fifth embodiment of the present invention.

FIG. 17 is a diagram showing the module configuration of a print system according to a sixth embodiment of the present invention.

### DESCRIPTION OF THE EMBODIMENTS

Hereinafter, a print system according to a first embodiment of the present invention will be described with reference to the attached drawings.

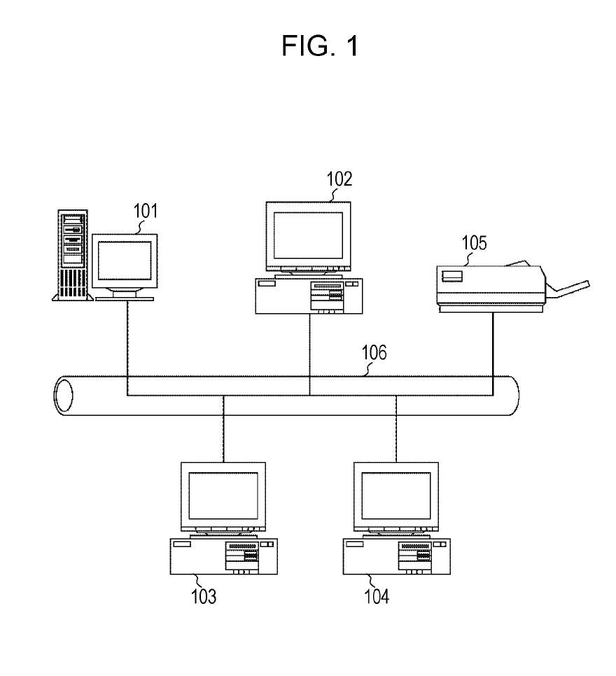

FIG. 1 shows the configuration of an image-forming system according to the above-described embodiment. Each of a management server 101, a print server 102, and client apparatuses 103 and 104 is achieved as a general information-processing apparatus connected to a network 106 through a network cable such as an Ethernet (registered trademark).

The information-processing apparatuses 103 and 104 are client apparatuses that can execute various types of programs including application programs, etc. A printer driver having the function of converting print data into a printer language provided for an image-forming apparatus such as a printer is installed in each of the information-processing apparatuses 103 and 104. Further, each of the information-processing apparatuses 103 and 104 is provided with a communication unit that can bidirectionally communicate with other devices connected to the network 106.

The printer driver supports a plurality of the image-forming apparatuses. Here, the image-forming apparatuses may be a laser-beam printer using an electrophotography method, an ink-jet printer using an ink-jet method, a printer using a thermal-transfer method, etc. Namely, the image-forming apparatuses may use any methods.

The management server 101 and the print server 102 are connected to the network 106 through the network cable so that they accumulate file data used on the network 106 and/or monitor the use status of the network 106.

The management server 101 and the print server 102 can also have the functions of the client apparatuses 103 and 104.

Further, the print server 102 can store print-job data including print data for which the client apparatuses 103 and 104 issue print requests, and transmit the print-job data to the image-forming apparatus. In another case, the print server 102 only receives job information transmitted from the client apparatuses 103 and 104, the job information including no print data, manages the order in which the jobs are printed, and notifies the client apparatus of which turn for printing comes that the transmission of the print-job data including the print data is permitted. Further, the print server 102 has the function of acquiring various types of information including information about the status of the image-forming apparatus and/or information about the print job and informing the client apparatuses 103 and 104 of the acquisition.

An image-forming apparatus 105 provided as a printer or the like is connected to the network 106 via a network interface which is not shown. Further, the image-forming apparatus 105 has the function of analyzing a print job including print data written in a print language or the like, the print job being transmitted from the client apparatuses 103 and 104, converting the print job into image data, and printing the image data, for example.

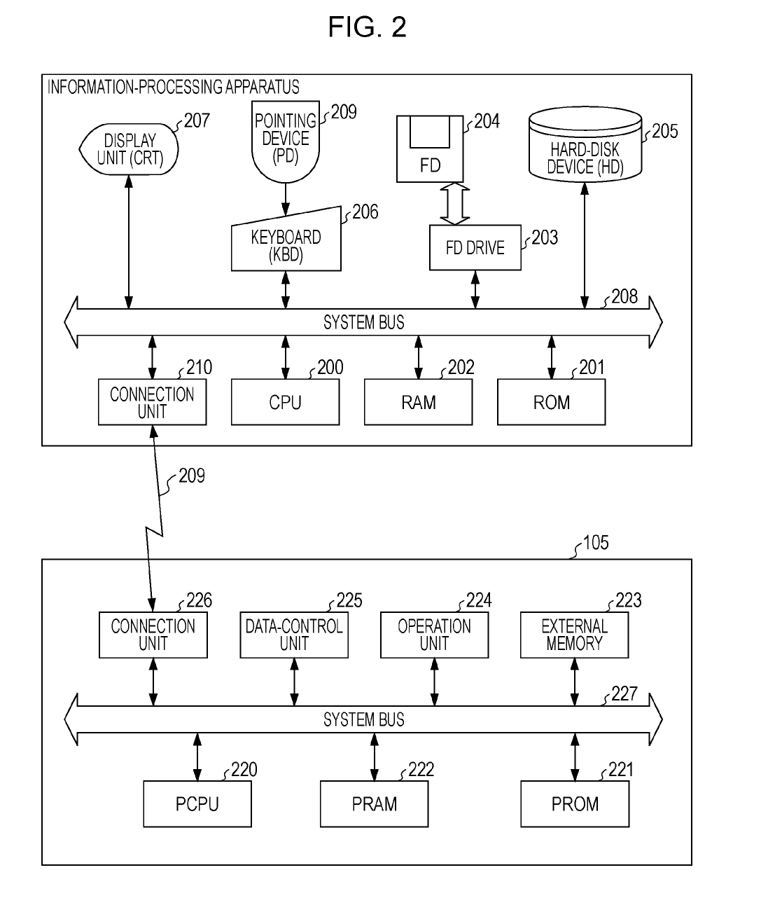

FIG. 2 is a schematic diagram showing the hardware configurations of the information-processing apparatus such as the client apparatus and the image-forming apparatus such as the printer.

First, the information-processing apparatus will be described.

A central-processing unit (CPU) 200 is provided as a control unit. The CPU 200 executes an application program, a printer-driver program, an operating system (which will be referred to as an OS), a network-printer-control program according to an embodiment of the present invention, and so forth. Further, the CPU 200 performs control, so as to temporarily store information, file data, etc. that are used to execute the above-described programs.

A read-only memory (ROM) 201 is provided as a storage unit. The ROM 201 stores at least one program such as a basic input/output (I/O) program and various data including font data, template data, etc. that are used during document processing.

A random-access memory (RAM) 202 is provided as a temporary storage unit and functions as a main memory, a work area, and so forth of the CPU 200.

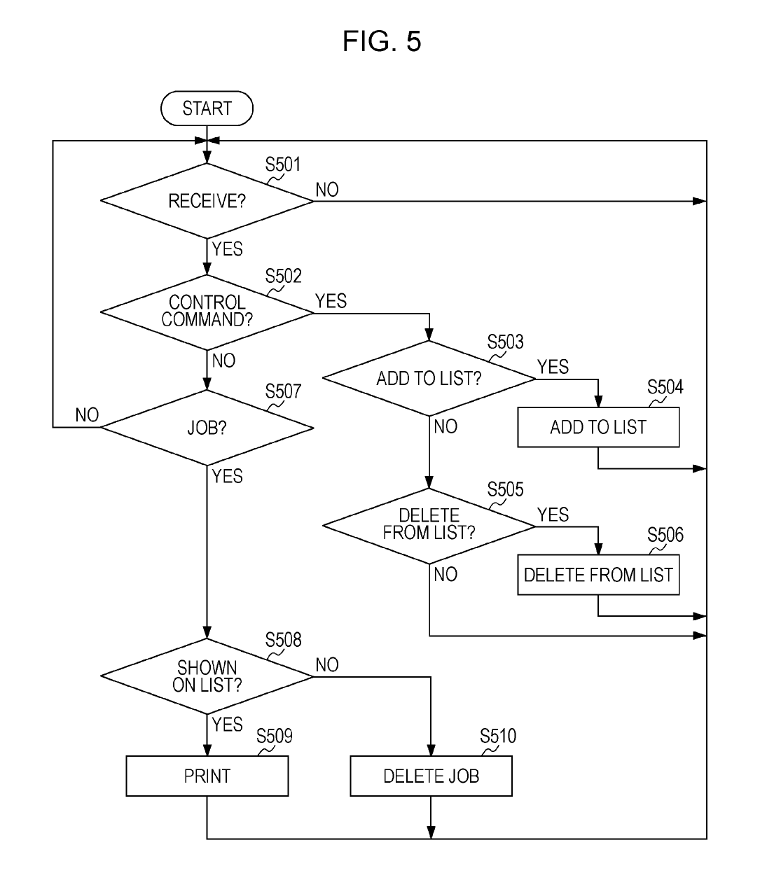

A floppy (registered trademark)-disk (FD) drive 203 is provided as a storage-medium-read unit. As shown in FIG. 5 which will be described later, a program or the like stored in an FD 204 provided as a storage medium can be loaded into the computer system, which is a client, via the above-described FD drive 203. Here, without being limited to the FD, the storage medium may be any of a compact disk (CD)-read only memory (ROM), a CD-recordable (R), a CD-rewritable (RW), a PC card, a digital-versatile disk (DVD), an IC-memory card, a magneto-optical disk (MO), a memory stick, and so forth.

At least one computer-readable program is stored in the FD 204.

A hard disk (HD) 205 is one of external storage units and functions as a large-capacity memory. An application program, a printer-driver program, an OS, a network-printer-control program, a related program, and so forth are stored in the HD 205. Further, a spooler is reserved in the HD 205. In the client apparatus, the spooler functions as a client spooler. In the print server, the spooler functions as a server spooler. Further, the print server stores the job information transmitted from the client apparatus, and data on a table provided to perform the order control is generated and stored in the above-described external storage unit.

A keyboard 206 is provided so that the user transmits, for example, data on a command for controlling the image-forming apparatus to the client apparatus through the keyboard 206. Further, an operator and/or an administrator transmits the data on the command for controlling the image-forming apparatus, for example, to the print server through the keyboard 206.

A cathode-ray tube (CRT) 207 is a display provided to display command data transmitted from the keyboard 206, an indication produced based on processing performed in the information-processing apparatus, status information acquired from the printer, and so forth.

A system bus 208 is configured to control data flowing through a computer functioning as the client apparatus.

A bidirectional interface 209 is provided as an input/output unit so that the client apparatus receives and/or transmits data from and/or to an external device via the bidirectional interface 209.

In the above-described embodiment, a network-printer-control program and related data are directly loaded from the FD 204 into the RAM 202 and executed, for example. At other times, every time the network-printer-control program is operated from the FD 204, a network-printer-control program that had already been installed in the HD 205 may be loaded into the RAM 202. Here, a medium storing the network-printer-control program may be a CD-ROM, a CD-R, a PC card, a DVD, and an IC-memory card in addition to an FD. Further, it may be configured so that the network-printer-control program is stored in the ROM 201 and used as part of a memory map. The network-printer-control program may be directly executed by the CPU 200.

Next, the configuration of the image-forming apparatus will be described. The image-forming apparatus 2 includes a connection unit 226, a data-control unit (printer engine) 225, an operation unit 224, an external memory 223, a printer CPU (PCPU) 220, a printer RAM (PRAM) 222, and a printer ROM (PROM) 221 that will be described later in detail, as the main components thereof. The above-described components are connected to one another via the system bus 227.

The PCPU 220 is configured to control the entire image-forming apparatus 2. The PCPU 220 transmits an image signal to the data-control unit 225 at a printer-control command received by the connection unit 226 based on a control program stored in the PROM 221 and/or the external memory 223 that will be described later.

The PRAM 222 includes an area used to temporarily store various data as a main memory of the PCPU 220, where the area is used as a work-data area when the PCPU 220 performs control. The external memory 223 is connected to the other main components as an option, so as to store font data, an emulation program, form data, and so forth. The PROM 221 is a printer-internal memory storing various data, a printer-control program provided to control the image-forming apparatus, and so forth, as is the case with the external memory 223.

The data-control unit 225, which is the printer engine, receives an image signal transmitted from the control program stored in the PROM 221 and/or the control program via the system bus 227 and performs actual print processing under the control of the PCPU 220. The operation unit 224 includes an input unit such as an operation panel and/or an operation switch, a display unit such as a light-emitting diode (LED) panel or a liquid-crystal panel, and so forth, so as to accept an operation instruction transmitted from an operator and/or display the result of processing procedures performed in the apparatus.

The connection unit 226 can connect to the connection unit 210 of the information-processing apparatus 1 via the above-described bidirectional interface 209, so as to receive a print-control command and inform the information-processing apparatus 1 of the internal status of the image-forming apparatus, for example.

Further, it becomes possible to replace the above-described hardware with software implementing the same functions as those of the above-described units and/or devices.

The present invention may be used in either of the case where a client apparatus generating a print job, a print server transmitting the print job, and an administration server administering the system are provided as the same information-processing apparatus and the case where the above-described client apparatus, print server, and administration server are provided as independent information-processing apparatuses.

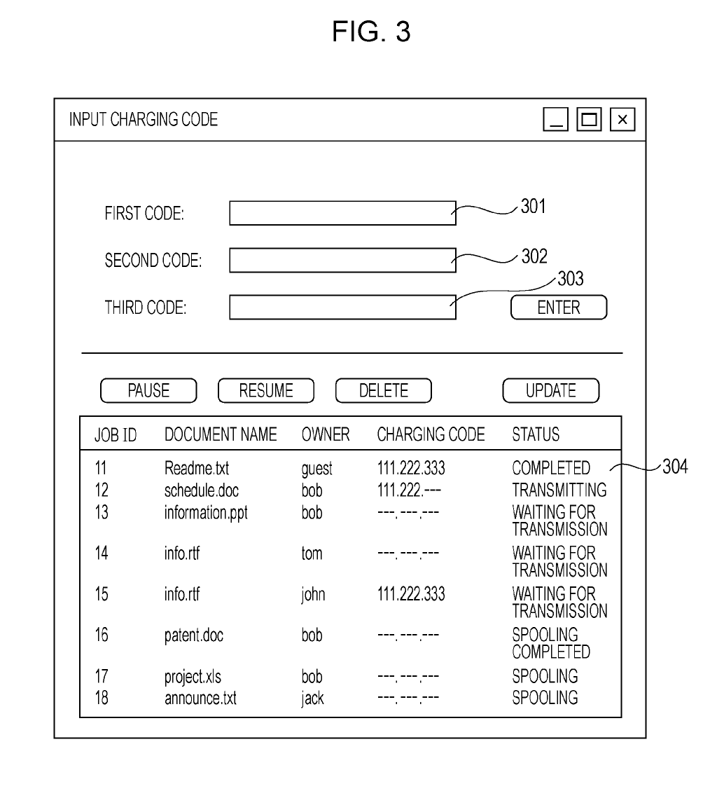

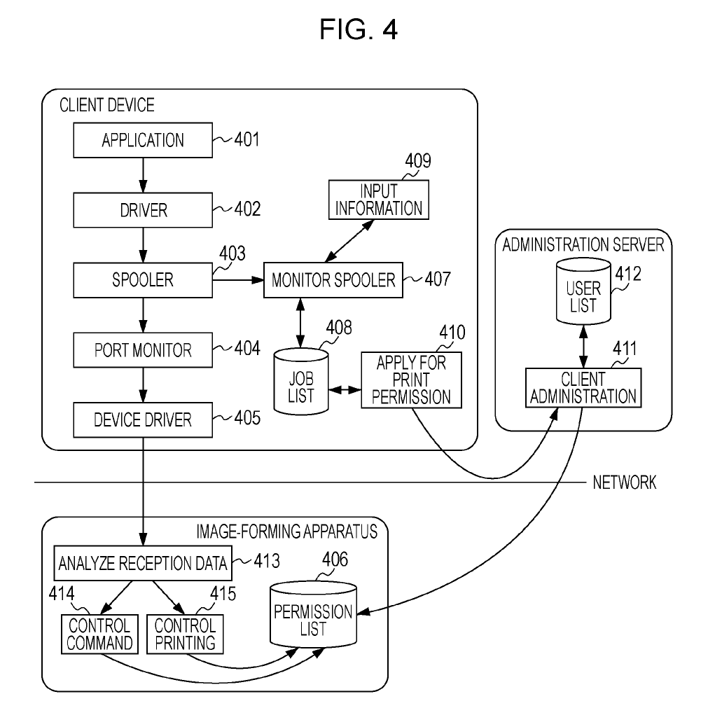

FIG. 3 shows an exemplary information-input-screen image according to the above-described embodiment. The above-described information-input-screen image or a dialogue image is a graphical user interface (GUI) displayed on the CRT 207 of the client apparatus through a spooler-monitoring module 407 shown in FIG. 4 which will be described later, so as to transmit an instruction issued by the user through the keyboard 206 or the like. The dialogue image includes a charging-code-input area, an input-determination button, a job-operation buttons (pause, resume, and delete) a display-update button, and a job-list-display part 304. On the job-list-display part 304, the job ID, the document name, the job owner, a charging code, and the status of the job are displayed on every line in list form. A plurality of the jobs may be selected according to an instruction issued by the user. The selected job is highlighted. When the job is selected, the charging-code-input areas 301 to 303 become effective so that an arbitrary character string can be input to each of the charging-code-input areas 301 to 303. The above-described input character string is associated with a job identified by the job ID which is selected and administered by the administration server while compilation relating to the jobs is performed.

FIG. 4 shows main modules operating on the client apparatus and those operating on the image-forming apparatus, where the client apparatus and the image-forming apparatus are included in the print system of the above-described embodiment.

The client apparatus is provided as a widely available personal computer (corresponding to the information-processing apparatus according to an embodiment of the present invention) using Windows (registered trademark) of Microsoft Corporation, as an OS. Further, an application 401 including Word (registered trademark) of Microsoft Corporation, which allows for providing an instruction to perform print processing, is started in the client apparatus.

The user generates document data by using the application 401 and issues a print instruction. The application 401 transmits data related to the document data to which the print instruction is issued to the printer driver 402, and the printer driver 402 generates a print job based on the data transmitted from the application 401 (job generation). The printer driver 402 transmits the generated print job to a spooler 403.

The spooler 403 schedules print jobs transmitted from a plurality of drivers for every specified image-forming apparatus. Then, the spooler 403 transmits the scheduled print jobs to a port monitor 404 provided for a connection port of the printer.

The port monitor 404 calls a device driver 405 provided for a port (e.g., a USB, a network, and so forth), as required, and transmits the print job to the device driver 405. The device driver 405 establishes connection with an image-forming apparatus 406 via the connection unit 210 by taking a cue from communication-data transmission (e.g., transmission of a synchronization (SYN) packet which will be described later). After that, the device driver 405 transmits the job by using the above-described connection.

The spooler-monitoring module 407 automatically starts operating when the client apparatus is started, and monitors the spooler 403. The spooler-monitoring module 407 monitors the addition, the deletion, and the change of the printer driver, and the generation and the status of a job for every printer driver. Upon detecting a job generated in the spooler 403, the spooler-monitoring module 407 stores the job in a job list (storage area) 408 with attached information including information about the status, the size, the printer-driver name, the owner, the document name, the date and time, etc. At the same time, a user interface (UI) 409 is displayed, so as to input information. The information-input UI 409 displays an exemplary information-input-dialogue image shown in FIG. 3 on the CRT 207 of the client apparatus. Upon receiving information input by the user, the information-input UI 409 incorporates the input information into information shown on the job list 408.

A print-permission-application module 410 automatically starts operating when the client apparatus is started and monitors the job list 408. In response to updating of the job list, the updating being performed based on a predetermined instruction issued by the user, the print-permission-application module 410 applies for permission to perform printing through an image-forming apparatus specified by the user to a client-administration module 411 of the administration server. Namely, the print-permission-application module 410 generates the application for permission to execute the job. After generating the permission application, the print-permission-application module 410 transmits the permission application to the client-administration module 411.

The image-forming apparatus includes a reception-data-analysis module 413, a print-control module 415, a command-control module 414, and a permission list 406.

The reception-data-analysis module 413 analyzes data transmitted from the client apparatus. If the reception data is command data (described later) other than the print job, the reception-data-analysis module 413 transmits the reception data to the command-control module 414. If the reception data is the print job, the reception-data-analysis module 413 transmits the print job to the print-control module 415.

The command-control module 414 analyzes the command data transmitted from the client apparatus, and performs control based on the command data. For example, if the command data is a status request, the command-control module 414 determines the command data to be a status-response command, and transmits information about the status (the error status or the like) of the image-forming apparatus to the client apparatus, as a response.

The print-control module 415 analyzes a print job transmitted from the client apparatus and executes printing.

The permission list 406 retains identification information used to identify a client apparatus permitted to print.

The print-control module 415 refers to the permission list 406 when the print processing is executed and executes print jobs in sequence, the print jobs being transmitted from the client apparatus permitted to print.

Upon receiving the job information and/or client information transmitted from the print-permission-application module 410 of the client apparatus, the client-administration module 411 of the administration server searches a user list 412, so as to determine whether the user concerned is registered. If the user is registered, the client-administration module 411 informs the image-forming apparatus concerned that the client apparatus is permitted to print.

Upon receiving the application for the print permission, the application being transmitted from the client-administration module 411 of the administration server, the image-forming apparatus adds identification information used to identify the client apparatus for which the print-permission application is made to the permission list 406.

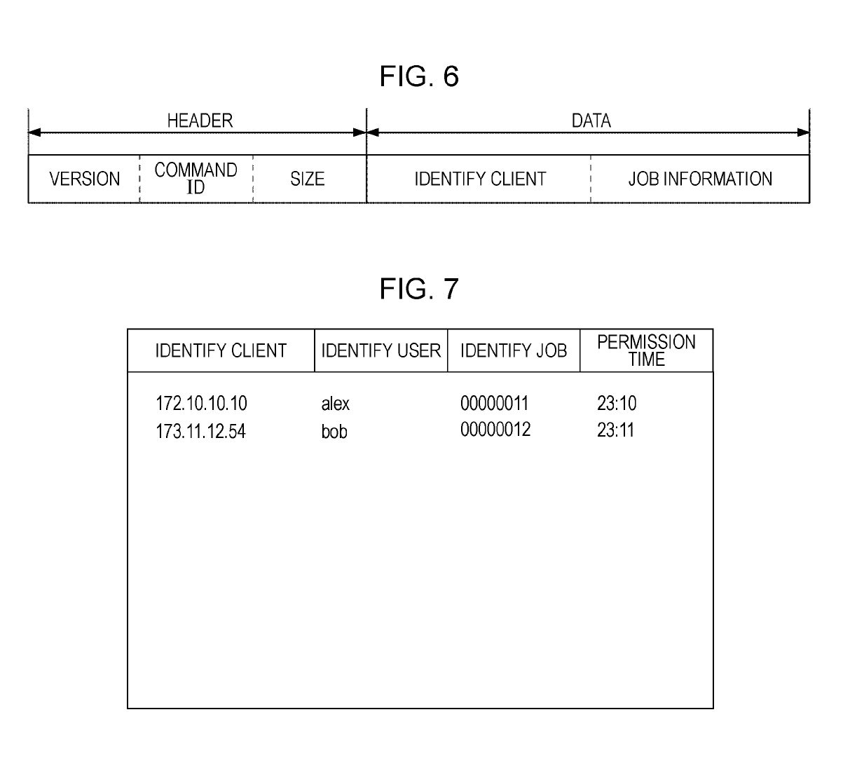

FIG. 6 shows an exemplary communication packet transmitted from the administration server when information is added to and/or deleted from the permission list 406 of the above-described embodiment.

The details of the communication packet include a common header and a data area. The common header includes information about the version, the packet size (packet length), a command ID provided to uniquely determine a command, and so forth, which becomes a format shared among all packets.

The data area includes arbitrary information depending on commands. For example, when the communication packet is provided to transmit a job, the command includes data which reads 0 indicating the job, and the data area includes job data (such as print data).

A data area provided for a list-addition command (such as a permission command which will be described later) provided to add information to the permission list of the image-forming apparatus and a list-deletion command stores client-identification information used to identify client apparatuses, job-identification information, and so forth.

The client-identification information includes, for example, information provided to identify a client apparatus, which shows the host name, the IP address, the MAC address, and so forth, and information provided to identify a user using the client apparatus, which shows the user name, the user ID, and the nickname of the user, for example.

The job-identification information includes at least information provided to uniquely identify a job, the information exemplarily showing a spooler ID, the document name, the job ID, a hash value generated based on the job data, and so forth.

FIG. 7 shows an exemplary permission list maintained by the image-forming apparatus of the above-described embodiment. Data on the permission list is maintained in advance in an area allocated in a storage device such as the PRAM 222.

A single record of the permission list includes the client-identification information, the user-identification information, the job-identification information, and information about permission time.

Information provided to identify a client apparatus, the information showing the host name, the IP address, the MAC address, and so forth, is set, as the client-identification information.

Information provided to identify a user using a client apparatus, the information showing the user name, the user ID, the nickname of the user, and so forth, is set, as the user-identification information.

Information provided to uniquely identify a job, the job information showing the spooler ID, the document name, the job ID, the hash value generated based on the job data, and so forth, is set, as the job information.

Information about the time when permission to print is granted is set, as the permission-time information.

Hereinafter, the above-described embodiment will be described with reference to FIGS. 5, 8, 9, 10, 11, and 12.

The IP-address information will be exemplarily described, as the client-identification information provided to identify a client apparatus.

FIG. 5 shows an exemplary flowchart showing processing procedures performed based on a program executed by the image-forming apparatus of the above-described embodiment.

At step S501, the reception-data-analysis module 413 determines whether data is received. If the data is received from the network via the bidirectional interface 209 and the connection unit 226, the data is stored in a work area allocated in a storage device such as the PRAM 222. Here, the above-described step is repeated until the data is received (being on standby). If it is determined that the data is received at step S501, the processing advances to step S502.

At step S502, the reception-data-analysis module 413 determines whether the reception data is command data other than the print job (a control command). That is to say, the reception-data-analysis module 413 analyzes the reception data stored in the work area allocated in the storage device such as the PRAM 222 by using the PCPU 220, and if the reception data is determined to be data generated in a predetermined control-command format, the reception-data-analysis module 413 determines the reception data to be the control command.

If the reception data is determined to be the control command at step S502, the command-control module 414 determines whether the reception data is the list-addition command at step S503. Here, the command-control module 414 analyzes the reception data stored in the work area allocated in the storage device such as the PRAM 222 by using the PCPU 220. If the reception data is generated in a predetermined list-addition-command format, the command-control module 414 determines the reception data to be the list-addition command.

If the command-control module 414 determines the reception data to be the list-addition command (e.g., a permission command which will be described later) at step S503, the processing advances to step S504. At step S504, the command-control module 414 adds information about a client specified by the received list-addition command (the client-identification information) to the permission list 406. Here, the client-identification information stored in the data area shown in FIG. 6 (such as the IP-address information) is retrieved from the reception data stored in the work area allocated in the storage device such as the PRAM 222 by using the PCPU 220. Then, the client-identification information is added to the permission list 406 stored in the storage device such as the PRAM 222. For example, if the permission-command reception, which will be described later, is performed in the above-described embodiment, the client-identification information, the job-identification information, the permission-time information, and so forth that are included in the permission command are added to the permission list in association with one another. Then, the processing returns to step S501.

If the command-control module 414 determines that the reception data is not the list-addition command at step S503, it is determined whether the reception data is the list-deletion command at step S505. Here, the command-control module 414 analyzes the reception data stored in the work area allocated in the storage device such as the PRAM 222 by using the PCPU 220. If the reception data is generated in a predetermined list-deletion-command format, the command-control module 414 determines the reception data to be the list-deletion command.

Next, if the reception data is determined to be the list-deletion command, the command-control module 414 deletes a record specified by the list-deletion command from the permission list 406 at step S506. Here, the client-identification information (the IP-address information) stored in the data area shown in FIG. 6 is retrieved from the reception data stored in the work area allocated in the storage device such as the PRAM 222 by using the PCPU 220. Next, a record including the above-described client-identification information is deleted from the permission list maintained in the storage device such as the PRAM 222. Then, the processing returns to step S501.

If it is determined that the reception data is not the control command at step S502, the reception-data-analysis module 413 determines whether the reception data is a print job at step S507. Namely, the reception-data-analysis module 413 analyzes the reception data stored in the work area allocated in the storage device such as the PRAM 222 by using the PCPU 220. If the reception data is generated in a predetermined print-job format, the reception-data-analysis module 413 determines the reception data to be the print job.

If the reception-data-analysis module 413 determines that the reception data is not the print job at step S507, the reception data is determined to be data which should not be processed by the above-described program and the processing returns to step S501. If the reception-data-analysis module 413 determines the reception data to be the print job at step S507, the processing advances to step S508.

At step S508, the print-control module 415 searches the permission list 406 and determines whether printing performed based on the received print job is permitted. Namely, the print-control module 415 analyzes the print job stored in the work area allocated in the storage device such as the PRAM 222 by using the PCPU 220, and acquires the client-identification information (the IP-address information) provided to identify the client apparatus which transmitted the print job and the job-identification information provided to identify the print job. After that, the print-control module 415 compares the permission list stored in the storage device such as the PRAM 222 with the client-identification information and the job-identification information that are acquired from the print job. If the client-identification information and the job-identification information are shown on the permission list, it is determined that the print permission is granted.

If it is determined that the print permission is granted at step S508, the print-control module 415 issues an instruction to perform printing based on the print job at step S509. After that, the processing returns to step S501. If it is determined that the print permission is not granted at step S508, the print-control module 415 deletes the received print job without performing printing at step S510. Then, the processing returns to step S501.

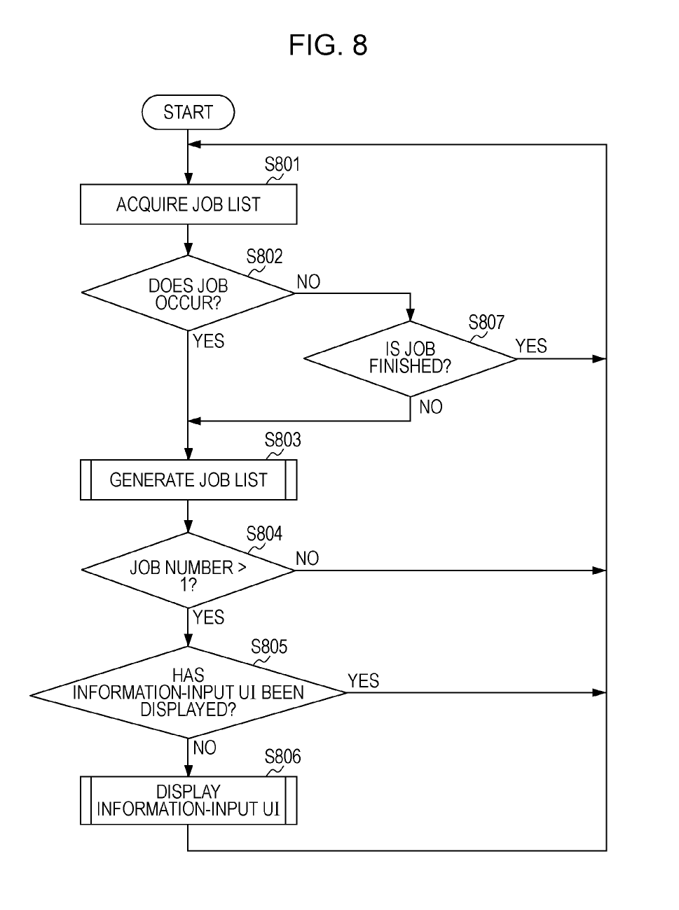

FIG. 8 shows the flow of processing procedures performed based on a program executed in the client apparatus of the above-described embodiment. The processing procedures become basic operations of the spooler-monitoring module 407.

At step S801, the list of acquired jobs is acquired. For example, the Win32 function Enumjob( ) prepared in Windows (registered trademark) of Microsoft Corporation is called, and the list of the print jobs is acquired and stored in the work area allocated in a storage device including the RAM 202, the HD 205, and so forth in advance.

Next, at step S802, it is determined whether a new job occurs on the job list acquired at the above-described step S801. Namely, the CPU 200 compares the acquired job list with the job list 408. If a job provided with a new job ID is added to the acquired job list, it is determined that the new job occurs.

If it is determined that the new job occurs at step S802, the new job shown on the job list acquired at step S801 and information attached to the new job are added to the job list 408 at step S803. Information attached to each job, the information showing the job ID, the document name, and so forth, is administered on the job list 408 on a job-by-job basis. Further, additional information added to each job through a predetermined application, the additional information showing a charging code or the like, is also administered on the job list 408 on a job-by-job basis. Here, the information attached to a job is acquired by using the Win32 function GetJob( ) prepared in Windows (registered trademark) of Microsoft Corporation, for example.

Next, it is determined whether at least one job is shown on the job list 408 at step S804. Namely, the CPU 200 searches the job list 408 and calculates the number of records shown on the job list 408. If it is determined that the at least one job is not shown on the job list 408, the processing returns to step S801.

If it is determined that the at least one job is shown on the job list 408 at step S804, it is determined whether the information-input UI 409 had already been displayed at step S805. For example, when the Win32 function FindWindow ( ) prepared in Windows (registered trademark) of Microsoft Corporation is called and a window used by the information-input UI 409 is shown, it is determined that the information-input UI 409 had already been displayed. If the information-input UI 409 had already been displayed, the processing procedures from step S801 onward are repeated.

If it is determined that the information-input UI 409 had not been displayed at step S805, the information-input UI 409 is displayed on a display device such as the CRT 207 based on predetermined procedures at step S806.

If the occurrence of the new job is not detected at step S802, it is determined whether the job is completed at step S807. Here, the CPU 200 compares the job list acquired at step S801 with the job list 408. If a job shown on the job list 408 is not shown on the acquired job list, it is determined that the job of which data is retained on the job list 408 is completed. Further, the completed job may be deleted from the job list 408 at that time.

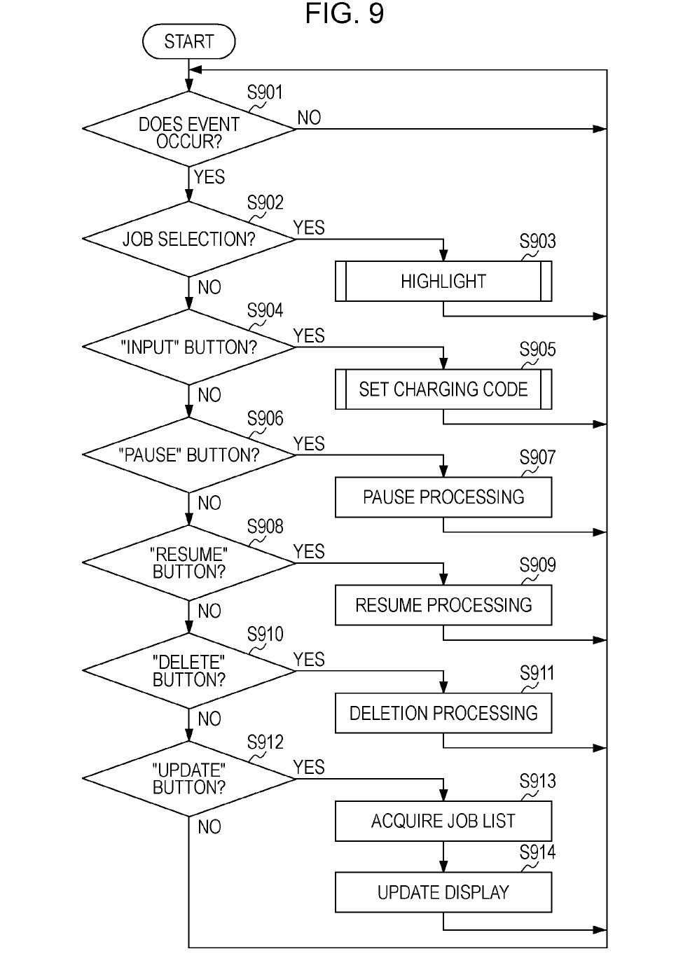

FIG. 9 shows an exemplary flow of processing procedures performed to accept an instruction transmitted via the information-input UI 409 of the above-described embodiment.

At step S901, it is determined whether an event that a button or the like shown on a screen image is pressed with a mouse-click occurs at step S901. For example, according to a method disclosed in MSDNLibrary (registered trademark) of Microsoft Corporation, an ID which uniquely determines operations including the mouse-click, keyboard inputting, and so forth, and each of resources including buttons, list boxes, and so forth that are shown in a window is notified, as an event. Here, the client apparatus waits until the event occurs.

If it is determined that the event occurs at step S901, it is determined whether the event is the job selection at step S902. Namely, it is determined whether any of records displayed on the job-list-display part 304 shown in FIG. 3 is selected based on the notified event.

If it is determined that the notified event is the job selection at step S902, the record concerned is highlighted on the screen image at step S903 so that the user can identify the record.

If it is determined that the notified event is not the job selection at step S902, it is determined whether the button “input” is pressed at step S904. Namely, it is determined whether the button “input” shown in FIG. 3 is pressed based on the notified event.

If it is determined that the notified event is the press of the button “input” at step S904, a charging code is set to a job stored in the job list 408, the job corresponding to a job selected on the job-list-display part 304, based on the job ID or the like of the selected job at step S905. Here, each of the values of the first code, the second code, and the third code is set in a charging-code area of the record of the job displayed on the job list 408.

If it is determined that the notified event is not the press of the button “input” at step S904, it is determined whether the button “pause” is pressed at step S906. That is to say, it is determined whether the button “pause” shown in FIG. 3 is pressed based on the notified event.

If the notified event is determined to be the press of the button “pause” at step S906, the job ID of the job selected on the job-list-display part 304 is acquired at step S907. Next, the job concerned is specified by using the Win32 function SetJob ( ) prepared in Windows (registered trademark) of Microsoft Corporation, and pause processing is performed for the job.

If it is determined that the notified event is not the press of the button “pause” at step S906, it is determined whether the button “resume” is pressed at step S908. Namely, it is determined whether the button “resume” shown in FIG. 3 is pressed based on the notified event.

If it is determined that the notified event is the press of the button “resume” at step S908, the job ID of the job selected on the job-list-display part 304 is acquired at step S909. Next, the job concerned is specified by using the Win32 function SetJob ( ) prepared in Windows (registered trademark) of Microsoft Corporation, and the selected job is resumed.

If it is determined that the notified event is not the press of the button “resume” at step S908, it is determined whether the button “delete” is pressed at step S910. Namely, whether the button “delete” shown in FIG. 3 is pressed is determined based on the notified event.

If the notified event is determined to be the press of the button “delete” at step S910, the job ID of the job selected on the job-list-display part 304 is acquired at step S911. Next, the job concerned is specified by using the Win32 function SetJob ( ) prepared in Windows (registered trademark) of Microsoft Corporation, and the selected job is deleted.

If it is determined that the notified event is not the press of the button “delete” at step S910, it is determined whether the button “update” is pressed at step S912. Namely, whether the button “update” shown in FIG. 3 is pressed is determined based on the notified event.

If the notified event is determined to be the press of the button “update” at step S912, the job list is re-acquired at step S913. For example, the list of the jobs and information items attached to the jobs is re-acquired by using the Win32 functions EnumJob ( ), GetJob ( ), and so forth that are prepared in Windows (registered trademark) of Microsoft Corporation. Here, information about the job list 408 is updated based on the acquired job information.

Next, at step S914, information displayed on the job-list-display part 304 shown in FIG. 3 is updated based on information about the job list 408 updated at step S913.

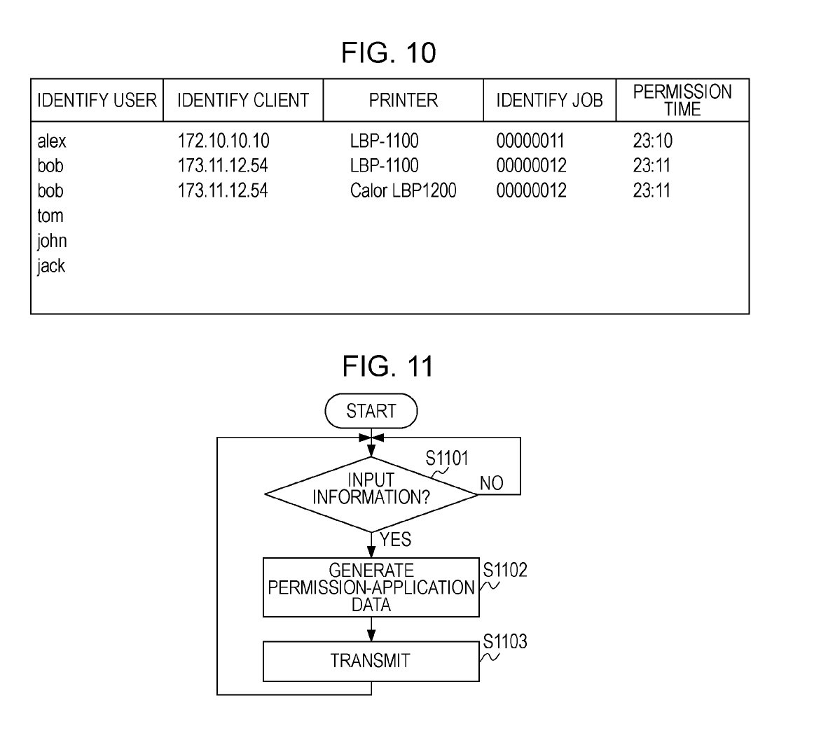

FIG. 10 shows an example of the permission list maintained by the client-administration module 411 of the administration server of the above-described embodiment.

The permission list is retained in an area allocated in a storage device such as the RAM 202, the HD 205, and so forth of the administration server. A single record of the permission list includes user-identification information, client-identification information, image-forming-apparatus information, job-identification information, permission-time information, and so forth.

Information provided to identify the user of the client apparatus is stored in the column of the user-identification information, where the information indicates the user name, the user ID, the nick name of the user, and so forth. The above-described embodiment allows for registering users to whom the print permission is granted upon receiving the print-permission application. Each of the registered users is written on the permission list.

Information provided to identify a client apparatus is stored in the column of the client-identification information, where the information indicates the host name, the IP address, the MAC address, and so forth. The column of the client-identification information is blank until the print application is accepted.

Information provided to identify an image-forming apparatus which issues a request to perform printing is stored in the column of the image-forming apparatus, where the information indicates the IP address, the host name, the MAC address, and so forth.

Identification information provided to uniquely identify a job is stored in the column of the job information, where the identification information indicates the spooler ID, the document name, the job ID, a hash value generated based on the job data, and so forth.

Information about the time where permission for the print application is granted is set in the column of the permission time.

FIG. 11 shows an exemplary flow showing basic operations of the print-permission-application module 410 of the above-described embodiment.

It is determined whether the user inputs the additional information at step S1101. Namely, when the job list 408 is searched by using the CPU 200 and a record in which the additional information is written is detected, it is determined that there is a job to which the additional information is input by the user.

If it is determined that the additional information is input by the user at step S1101, data on an application for permission to perform printing is generated at step S1102, where the data is transmitted to the client-administration module. The generated data includes a data packet storing information about the IP address of a client apparatus, a log-in user name, job-identification information, and the IP address of a printer which issues a request to perform printing.

Next, the print-permission-application data generated at step S1102 is transmitted to the client-administration module 411 of the administration server at step S1103.

If it is determined that the additional information is not input by the user at step S1101, the processing of step S1101 is repeated.

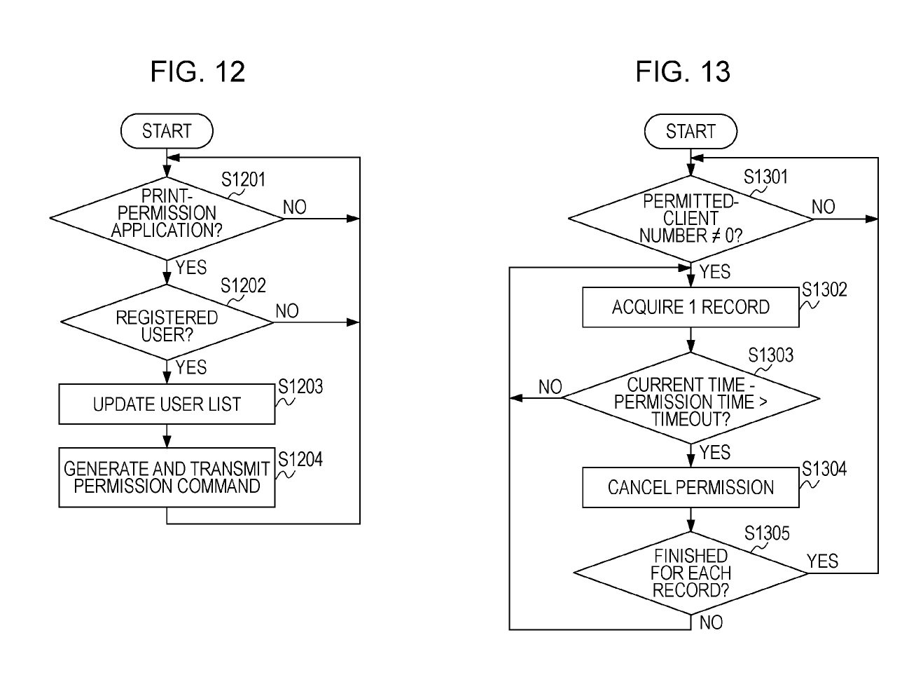

FIG. 12 shows an exemplary flow of basic operations of the client-administration module 411 of the administration server of the above-described embodiment.

At step S1201, it is determined whether the permission-application data is received from the client apparatus. If the permission-application data is received from the network via the bidirectional interface 209 and the connection unit 226, the permission-application data is stored in the work area allocated in a storage device such as the RAM 202, the HD 205, and so forth. The above-described step is repeated until the permission-application data is received.

When the permission-application data is received at step S1201, it is determined whether the permission-application data is the print-permission application transmitted from the user registered with the user list 412 at step S1202. Here, the user information is acquired from the permission-application data and the user list 412 is searched for the user information. If the same user information is detected, the permission-application data is determined to be the print-permission application transmitted from the registered user.

If the permission-application data is determined to be the print-permission application transmitted from the registered user at step S1202, the user list 412 is updated at step S1203. More specifically, the above-described user list, which is provided to administer the upper limit of each user, administers the current monthly number of printing of each user in addition to the user-identification information. When the upper limit of the number of printing of a user identified by the user-identification information is exemplarily determined on a monthly basis and the above-described upper limit is reached at the time when the print-permission application is received, information about the user is temporarily deleted from the user list. Consequently, it becomes difficult for the user to perform printing on that month. The time period over which the upper-limit administration is performed may be arbitrarily determined. Further, the administration object is not limited to the number of printing. Namely, the administration object may be any of various print settings and functions that can be presented by an image-forming apparatus. Still further, data of the actual result of the number of printing, which is administered through the user list, may be updated at the permission-application-reception time. However, precise implementation may be achieved by receiving an execution notification after the processing is executed in the image-forming apparatus, and calculating the actual result based on the execution notification.

Next, at step S1204, a permission command is generated in the format shown in FIG. 6 through processing performed by the CPU 200, so as to add information to the permission list of the image-forming apparatus. Further, the client-identification information, the user-identification information, and the job-identification information are acquired from the permission-application data retained in the work area. Further, information about the current time is acquired and set to the permission command. Next, the generated permission command is transmitted to an image-forming apparatus of which data is acquired from the permission-application data retained in the work area. Additional information including charging-destination information or the like may be added to the permission command.

If it is determined that the print-permission application is transmitted from a user other than the registered users at step S1202, the processing returns to step S1201.

In the case where a command is generated in the format (FIG. 6) of the command for adding information to the permission list used in the above-described embodiment, the image-forming apparatus determines the above-described command to be the command for adding information to the permission list. Consequently, data of the permission list is updated as occasion arises.

According to a second embodiment of the present invention, a timeout is provided after the image-forming apparatus receives the permission command and the print permission granted to the user is automatically cancelled. Hereinafter, differences between the second embodiment and the first embodiment will be described with reference to FIG. 13.

FIG. 13 shows the flow of timeout-monitoring-processing procedures performed based on a program retained in the image-forming apparatus. The timeout-monitoring-processing procedures are performed independently of the processing procedures of the flow shown in FIG. 5, where the processing procedures are performed by the image-forming apparatus.

It is determined whether the number of at least one client apparatus permitted to print is zero by searching the permission list stored in a storage device such as the PRAM 222 through the PCPU 220 at step S1301.

If it is determined that the number of the client apparatus permitted to print is zero at step S1301, the processing returns to step S1301.

If it is determined that the number of the client apparatus permitted to print is not zero at step S1301, a single record is retrieved from the permission list through the PCPU 220 and stored in a work area allocated in a storage device such as the PRAM 222 at step S1302.

Next, the PCPU 220 acquires information about the current time from a clock or the like owned by the image-forming apparatus at step S1303. Then, it is determined whether the amount of time elapsed from the permission time set to the record acquired at step S1302 exceeds the value of the timeout that had been set and retained in the image-forming apparatus.

When determining the timeout of the permission information (record) shown on the permission list, information about the permission time may be directly incorporated into the permission command and received from the administration server. Accordingly, the image-forming apparatus can make the above-described determination by administering the time when the permission command is received and comparing the reception time with the permission time without retaining information about the timeout value.

If it is determined that the amount of the time elapsed from the permission time exceeds the timeout value at step S1303, the print permission granted to the user of the record concerned is cancelled at step S1304. Namely, the record concerned is deleted from the permission list retained in the storage device such as the PRAM 222 through the PCPU 220.

Next, it is determined whether the timeout calculation is performed for each of the records through the PCPU 220 at step S1305.

If it is determined that the timeout calculation is completed for each of the records at step S1305, the processing returns to step S1301.

If it is determined that the timeout calculation is not completed for each of the records at step S1305, the processing returns to step S1302, so as to acquire the next record shown on the permission list.

If it is determined that the amount of the time elapsed from the permission time does not exceed the timeout value at step S1303, the processing returns to step S1302, so as to acquire the next record shown on the permission list.

According to another embodiment of the present invention, the same effect can be obtained by monitoring the timeout and applying for the cancellation of the print permission through the administration server and/or the client apparatus.

Each of the above-described embodiments is susceptible to the following improvement. Namely, after making the permission application in the client apparatus, the permission granted to the user of the client apparatus is automatically cancelled in accordance with the completion of the job corresponding to the permission application transmitted to the image-forming apparatus.

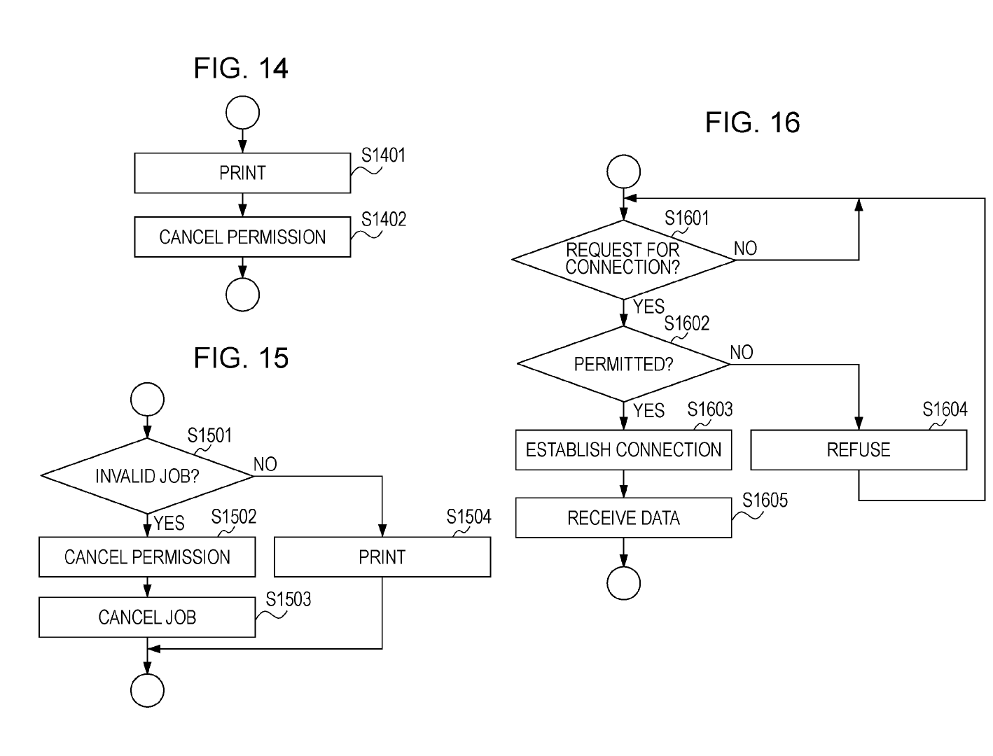

In a third embodiment of the present invention, an example where the print permission is cancelled in the image-forming apparatus will be described. An improvement in the processing corresponding to step S509 shown in FIG. 5 will be described with reference to FIG. 14, as the difference between the third embodiment and the above-described embodiments.

If it is determined that the print permission is granted at step S508 shown in FIG. 5, the print-control module 415 executes printing based on a job transmitted thereto at step S1401.

Next, the print-control module 415 cancels the print permission after the printing is finished at step S1402. Namely, a record provided with the same job-identification information as that of the job printed at step S1401 is deleted from the permission list retained in a storage device such as the PRAM 222 through the PCPU 220. Then, the processing returns to step S501.

Consequently, it becomes possible to grant the print permission to each client apparatus and/or user who makes a permission application for transmitting a job, and cancel the print permission strictly on a job-by-job basis.

The first embodiment may be improved so that even though a client apparatus to which the print permission is granted requests printing, an image-forming apparatus cancels the print permission when a job transmitted from the client apparatus is invalid. An improvement in the processing corresponding to step S509 shown in FIG. 5 will be described with reference to FIG. 15, as the difference between the first embodiment and a fourth embodiment of the present invention.

If it is determined that the print permission is granted at step S508 shown in FIG. 5, the print-control module 415 determines whether the job is invalid at step S1501.

For example, the permission list of which data is stored in a storage device such as the RAM 222 is searched and the hash value of the job, where data of the hash value is included in the job-identification information, is compared with a hash value generated based on a job received via the bidirectional interface 209. If the comparison result shows that the above-described hash values are different from each other, it is considered that the job is tampered after the print permission is granted and the job is determined to be invalid. Or, if the job is not generated in a predetermined format, it is determined that the job is invalid.

If it is determined that the job is invalid at step S1501, the print-control module 415 cancels the print permission granted to the client apparatus that had transmitted the invalid job at step S1502. Namely, a record provided with the same client-identification information as that of the job determined at step S1501 is deleted from the permission list retained in a storage device such as the PRAM 222 through the PCPU 220.

Next, the job concerned is not printed, but deleted by the print-control module 415 at step S1503.

If it is determined that the job is not invalid at step S1501, the print-control module 415 prints the job concerned at step S1504. Then, the processing returns to step S501.

Each of the above-described embodiments is susceptible to the following improvement. Namely, the image-forming apparatus controls printing by limiting communications performed between the image-forming apparatus and the client apparatus. The difference between a fifth embodiment of the present invention and the above-described embodiments will be described with reference to FIG. 16.

In the fifth embodiment, data on the IP address of the administration server is registered with the permission list retained in a storage device such as the PRAM 222 of the image-forming apparatus in advance. Consequently, communications are established and assured between the image-forming apparatus and the administration server.

FIG. 16 shows the flow of operations performed by the reception-data-analysis module 413 of the image-forming apparatus, so as to start the connection of the network communications. More specifically, the processing corresponding to step S501 shown in FIG. 5 is improved.

A request for the communication connection is accepted at step S1601. Namely, communication data used to establish a connection is received from the client apparatus or the like via the bidirectional interface. For example, data referred to as a SYN packet is received in the case where widely available TCP communication is performed.

Next, it is determined whether the source of a request for the connection, where information about the request source is included in the packet of the communication data received at step S1601, is permitted to communicate at step S1602. Namely, a search is made by using the PCPU 220, so as to determine whether the identification information of the connection-request source (the client apparatus), the identification information being acquired at step S1601, is included in the client-identification information shown on the permission list. If the identification information is included in the client-identification information, it is determined that the connection-request source is permitted to communicate. For example, in the case where TCP communication, which is a widely available network-communication system, is performed, the IP address of the transmission source is provided on the IP header of the SYN packet. If the IP address is provided in the client-identification information shown on the permission list, it is determined that the communication permission had already been granted.

If it is determined that the communication permission is granted at step S1602, a connection reply is made at step S1603. For example, in the case where widely available TCP communication is performed, an ACK packet is transmitted. From then on, a communication path is established at step S1603 by performing predetermined communication procedures, which enables to communicate with the communication-connection-request source.

Next, succeeding data (job) is received via the network at step S1605.

If it is determined that the communication permission is not granted at step S1602, the request is refused at step S1604. For example, the ACK packet is not transmitted in the case where widely available TCP communication is performed.

Next, the processing returns to step S1601.

According to the above-described embodiment, whether a connection should be established between the client apparatus and the image-forming apparatus is determined by referring to the permission list so that an unpermitted user is prohibited from making access before an actual job is received. Consequently, the image-forming apparatus does not receive an invalid job at all, which allows for reducing unnecessary processing procedures performed in the image-forming apparatus. In the above-described embodiment, a job received as a print job transmitted from a permitted client apparatus may further be validated by using job-identification information retained on the above-described permission list in association with the client-identification information. An unpermitted print job is not subjected to the print processing, as is the case with the processing performed at step S510. The above-described configuration allows for preventing the invalid print job from being printed through the permitted client apparatus.

The first embodiment may be improved so that communications are limited by making network settings without providing the image-forming apparatus with particular functions. The difference between the first embodiment and a sixth embodiment of the present invention will be described. In the sixth embodiment, for example, the image-forming apparatus only performs processing, so as to print a print job transmitted thereto.

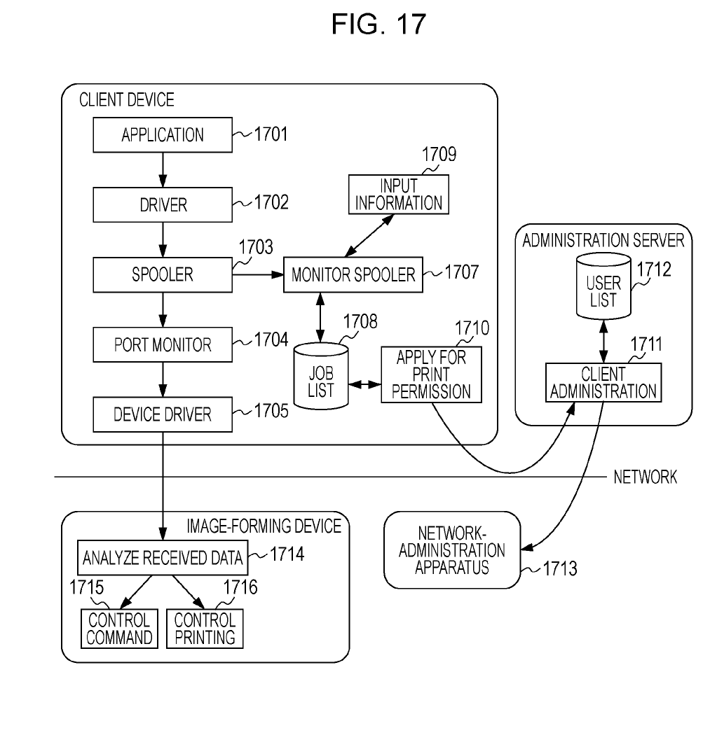

FIG. 17 is a schematic diagram of a print system according to the sixth embodiment. The print system includes a client apparatus, an image-forming apparatus, an administration server, and a network-administration apparatus. The sixth embodiment is different from the first embodiment in that the administration server and the network-administration apparatus are connected to each other via the network. Here, modules 1701 to 1705, 1707, 1709, 1714, and 1715 that are shown in FIG. 17 are configured as the same modules as those designated by reference numerals 401 to 405, 407, 409, 413, and 414 that are shown in FIG. 4, and the descriptions thereof are omitted.

A print-permission-application module 1710 of the client apparatus monitors a job list 1708. The print-permission-application module 1710 transmits permission-application data to a client-administration module 1711 of the administration server, so as to apply for granting a print permission to a desired printer based on an instruction transmitted from the user.

Upon receiving the permission-application data transmitted from the print-permission-application module 1710 of the client apparatus, the client-administration module 1711 of the administration server searches the user list 1712 based on the identification information included in the permission-application data and determines whether the user concerned is registered therewith. If the user is registered with the user list 1712, the client-administration module 1711 sets the communication permission granted to each of the client apparatus and the image-forming apparatus to a network-administration apparatus 1713.

The network-administration apparatus 1713 can control communications performed by a device connected to the network, where the device includes a gateway, a switching hub, and so forth. The network-administration apparatus 1713 makes a setting so that communications can be performed between the client apparatus and the image-forming apparatus that are permitted to communicate by the client-administration module 1711 of the administration server.

In a seventh embodiment of the present invention, an improvement in the first embodiment, which relates to the processing procedures that are performed in the administration server and illustrated in FIG. 12, will be described.

According to the seventh embodiment, when a print-permission application is transmitted from the client apparatus and the user of the client apparatus is permitted to print, a temporary identification information (temporary ID) is issued in the administration server. The above-described issued temporary ID is transmitted to the image-forming apparatus at step S1204 and administered on the permission list 406 in association with the client-identification information or the like. In addition, the administration server transmits the temporary ID to the client apparatus, as a response to the print-permission application.

When transmitting a print job to the image-forming apparatus, the client apparatus incorporates the temporary ID transmitted from the administration server in the print job and transmits the print job.

Upon receiving the print job, the image-forming apparatus determines whether the print job should be executed based on the temporary ID in place of the job-identification information. If a temporary ID registered with the permission list 406 in correspondence with the client-identification information agrees with the temporary ID included in the print job, the printing is permitted.

According to the improvement achieved in the seventh embodiment, the job identification is also achieved by using the temporary information which is issued not by the client apparatus but by the administration server, which is the third party. Consequently, the security of the print system increases. Further, the job-identification information may not be issued by the client apparatus and distributed to each device.

The above-described embodiments produce at least the following advantages.

According to the first embodiment, the user is permitted to print by inputting the additional information such as the charging-destination information to the job in the client apparatus, and it is difficult for the user to execute printing without inputting the additional information.

According to the second embodiment, the timeout is provided and the print permission is cancelled after a set period of time. The above-described advantage allows for discontinuing the print permission, which used to be kept in spite of the occurrence of an inconvenience of losing the job in transit, having difficulty in achieving communications between the administration server and the image-forming apparatus, and so forth.

According to the third embodiment, the print permission corresponding to a job is cancelled after the job is finished. Therefore, it becomes possible to reduce the time period over which the print permission is granted so that the security of the print system increases.

According to the fourth embodiment, it becomes possible to prevent an invalid job including a tampered job, a reproduced job, and so forth from being printed. Further, it becomes possible to cancel a permission granted to a client apparatus which transmitted the above-described invalid job.

According to the fifth embodiment, a print job transmitted from a client apparatus which is not permitted to print is not received by an image-forming apparatus. Therefore, it becomes possible to reduce redundant processing and/or unnecessary traffic which occurs in the image-forming apparatus.

According to the sixth embodiment, an image-forming apparatus may not be provided with particular functions. It becomes possible to use a print system according to an embodiment of the present invention for an image-forming apparatus that had already been available on the market without making any particular modification to the image-forming apparatus.

While the present invention has been described with reference to exemplary embodiments, it is to be understood that the invention is not limited to the disclosed exemplary embodiments. The scope of the following claims is to be accorded the broadest interpretation so as to encompass all modifications and equivalent structures and functions.

This application claims the benefit of Japanese Patent Application No. 2007-314792 filed on Dec. 5, 2007 and Japanese Patent Application No. 2008-274348 filed on Oct. 24, 2008, which are hereby incorporated by reference herein in their entirety.

What is claimed is:

1. A print system including a client apparatus generating a job, an image-forming apparatus performing print processing based on a job transmitted from the client apparatus, and an administration apparatus controlling the print processing,
wherein the client apparatus comprises:
a job-generation unit configured to generate the job based on an instruction transmitted from a user;
a permission-application-generation unit configured to generate permission-application data including job-identification information provided to identify the generated job, client-identification information provided to identify the client apparatus, and user-identification information provided to identify the user, so as to apply for permission to execute the job in the image-forming apparatus;
a permission-application-transmission unit configured to transmit the generated permission-application data to the administration apparatus; and
a job-transmission unit configured to transmit the generated job to the image-forming apparatus,
wherein the administration apparatus comprises:
a permission-application-reception unit configured to receive the permission-application data transmitted from the client apparatus;
a user list provided to manage user-identification information provided to identify a user permitted to print data through the image-forming apparatus;
a permission-command-generation unit configured to generate a permission command provided to permit printing corresponding to the permission-application data, the permission command including the job-identification information and the client-identification information, based on a fact that the user-identification information included in the permission-application data is managed on the user list; and
a permission-command-transmission unit configured to transmit the generated permission command to the image-forming apparatus, and
wherein the image-forming apparatus comprises:
a permission-command-reception unit configured to receive a permission command transmitted from the administration apparatus;
a permission list provided to manage client-identification information provided to identify a client apparatus permitted to perform processing for the job;
a registration unit configured to register the client-identification information and the job-identification information with the permission list in association with each other, where the client-identification information and the job-identification information are included in the permission command received by the permission-command-reception unit;
a job-reception unit configured to receive the job transmitted from the client apparatus identified by the client-identification information managed on the permission list;
a print unit configured to execute print processing based on the job received by the job-reception unit; and
a permission-cancellation unit configured to delete the job-identification information of the job and the client-identification information managed in correspondence with the job-identification information that are shown on the permission list after the print unit executes the print processing based on the job.

2. The print system according to claim 1, wherein the client apparatus further comprises a communication-data-transmission unit configured to transmit communication data including the client-identification information, so as to establish a connection used to transmit the job generated by the job-generation unit to the image-forming apparatus,
wherein the image-forming apparatus further comprises:
a communication-data-reception unit configured to receive the communication data transmitted from the client apparatus;
a determining unit configured to determine whether the client-identification information included in the communication data received by the communication-data-reception unit is managed on the permission list; and
a response unit that is configured to give no response to the communication data when the determining unit determines that the client-identification information included in the communication data is not managed on the permission list and that is configured to give a response to the communication data for the client apparatus, the communication data being provided to establish the connection for transmitting the job between the client apparatus and the image-forming apparatus, when the determining unit determines that the client-identification information included in the communication data is managed on the permission list, and
wherein the job-reception unit receives the job after the connection is established for transmitting the job between the client apparatus and the image-forming apparatus in accordance with a result of the response given by the response unit.

3. The print system according to claim 1, wherein the permission-command-generation unit generates the permission command further including information about permission time when execution of the job is permitted,
wherein the registration unit registers the client-identification information, the job-identification information, and the permission-time information that are included in the permission command with the permission list in association with one another, and
wherein the permission-cancellation unit deletes information based on the permission-time information managed on the permission list, the information being managed in correspondence with the permission-time information.

4. The print system according to claim 1, wherein the job-identification information includes data of a hash value relating to the job generated by the job-generation unit,
wherein the image-forming apparatus further comprises an acquisition unit configured to acquire data of a hash value of the job received by the job-reception unit, and
wherein when data of a hash value of the job-identification information managed on the permission list in correspondence with the client-identification information of the client apparatus that received the job is different from the hash-value data acquired by the acquisition unit, the print unit does not execute the print processing based on the job and the permission-cancellation unit deletes information managed on the permission list in correspondence with the client-identification information.

5. The print system according to claim 1, wherein the administration unit further comprises:
an issuing unit configured to issue temporary-identification information based on a fact that the user-identification information included in the permission-application data is managed on the user list; and
a transmission unit configured to transmit the temporary-identification information issued by the issuing unit to the client apparatus,
wherein the permission-command-generation unit generates the permission command further including the issued temporary-identification information,
wherein the job-transmission unit of the client-apparatus transmits the temporary-identification information transmitted from the transmission unit with the job to the image-forming apparatus, and
wherein, in the image-forming apparatus,
the registration unit registers the client-identification information, the job-identification information, and the temporary-identification information that are included in the permission command with the permission list in association with one another, and
the print unit executes the print processing based on the job in accordance with a fact that the temporary-identification information included in the job is registered with the permission list in association with the client-identification information of the client apparatus from which the job is transmitted.

6. An information-processing method used in a print system including a client apparatus generating a job, an image-forming apparatus performing print processing based on a job transmitted from the client apparatus, and an administration apparatus controlling the print processing,
wherein the client apparatus performs:
generating the job based on an instruction transmitted from a user;
generating permission-application data including job-identification information provided to identify the generated job, client-identification information provided to identify the client apparatus, and user-identification information provided to identify the user, so as to apply for permission to execute the job in the image-forming apparatus;
transmitting the generated permission-application data to the administration apparatus; and
transmitting the generated job to the image-forming apparatus,
wherein the administration apparatus performs:
receiving the permission-application data transmitted from the client apparatus;
providing a user list to manage the user-identification information provided to identify a user permitted to print data through the image-forming apparatus;
generating a permission command provided to permit printing corresponding to the permission-application data, the permission command including the job-identification information and the client-identification information, based on a fact that the user-identification information included in the permission-application data is managed on the user list; and
transmitting the generated permission command to the image-forming apparatus, and
wherein the image-forming apparatus performs:
receiving a permission command transmitted from the administration apparatus;
providing a permission list to manage client-identification information provided to identify a client apparatus permitted to perform processing for the job;
registering the client-identification information and the job-identification information with the permission list in association with each other, where the client-identification information and the job-identification information are included in the permission command received at the permission-command-reception step;
receiving the job transmitted from the client apparatus identified by the client-identification information managed on the permission list;
executing print processing based on the job received at the job-reception step; and
cancelling the permission after the print processing is executed based on the job at the print step by deleting the job-identification information of the job for which the print processing executed and the client-identification information managed in correspondence with the job-identification information, where the job-identification information and the client-identification information are shown on the permission list.

7. The information-processing method according to claim 6, wherein the client apparatus further comprises transmitting communication data including the client-identification information, so as to establish a connection used to transmit the job generated at the job-generation step to the image-forming apparatus,
wherein the image-forming apparatus further performs:
receiving the communication data transmitted from the client apparatus;
determining whether the client-identification information included in the communication data received at the communication-data-reception step is managed on the permission list; and
giving no response to the communication data when it is determined that the client-identification information included in the communication data is not managed on the permission list at the determining step and giving a response to the communication data for the client apparatus, the communication data being provided to establish the connection for transmitting the job between the client apparatus and the image-forming apparatus, when it is determined that the client-identification information included in the communication data is managed on the permission list at the determining step, and
wherein, at the job-reception step, the job is received after the connection is established for transmitting the job between the client apparatus and the image-forming apparatus in accordance with a result of the response given at the response step.

8. The information-processing method according to claim 6, wherein, at the permission-command-generation step, the permission command further including information about permission time when execution of the job is permitted is generated,
wherein, at the registration step, the client-identification information, the job-identification information, and the permission-time information that are included in the permission command are registered with the permission list in association with one another, and
wherein, at the permission-cancellation step, information is deleted based on the permission-time information managed on the permission list, the information being managed in correspondence with the permission-time information.

9. The information-processing method according to claim 6, wherein the job-identification information includes data of a hash value relating to the job generated at the job-generation step,
wherein the image-forming apparatus further comprises acquiring data of a hash value of the job received at the job-reception step, and
wherein when data of a hash value of the job-identification information managed on the permission list in correspondence with the client-identification information of the client apparatus that received the job is different from the hash-value data acquired at the acquisition step, the print processing is not executed based on the job by performing the print step and information managed on the permission list in correspondence with the client-identification information is deleted at the permission-cancellation step.

10. An image-forming apparatus that can communicate with a client apparatus generating a job and an administration apparatus controlling print processing, the image-forming apparatus comprising:
a permission-command-reception unit configured to receive a permission command transmitted from the administration apparatus, the permission command including job-identification information of a job permitted to be printed and client-identification information of the client apparatus transmitting the job;
a permission list provided to manage client-identification information provided to identify a client apparatus permitted to perform processing for the job;
a registration unit configured to register the client-identification information and the job-identification information that are included in the permission command received by the permission-command-reception unit with the permission list in association with each other;
a job-reception unit configured to receive the job transmitted from the client apparatus identified by the client-identification information managed on the permission list;
a print unit configured to execute print processing based on the job received by the job-reception unit; and
a permission-cancellation unit configured to delete the job-identification information of the job and the client-identification information managed in correspondence with the job-identification information that are shown on the permission list after the print unit executes the print processing based on the job.

11. The image-forming apparatus according to claim 10, further comprising:
a communication-data-reception unit configured to receive communication data including client-identification information provided to establish a connection used to transmit the job from the client apparatus to the image-forming apparatus;
a determining unit configured to determine whether the client-identification information included in the communication data received by the communication-data-reception unit is managed on the permission list; and
a response unit that is configured to give no response to the communication data when the determining unit determines that the client-identification information included in the communication data is not managed on the permission list and that is configured to give a response to the communication data for the client apparatus, the communication data being provided to establish the connection for transmitting the job between the client apparatus and the image-forming apparatus, when the determining unit determines that the client-identification information included in the communication data is managed on the permission list, and
wherein the job-reception unit receives the job after the connection is established for transmitting the job between the client apparatus and the image-forming apparatus in accordance with a result of the response given by the response unit.

12. An information-processing method used in an image-forming apparatus that can communicate with a client apparatus generating a job and an administration apparatus controlling print processing, the information-processing method comprising:
receiving a permission command transmitted from the administration apparatus, the permission command including job-identification information of a job permitted to be printed and client-identification information of the client apparatus transmitting the job;
providing a permission list to manage client-identification information provided to identify a client apparatus permitted to perform processing for the job;
registering the client-identification information and the job-identification information that are included in the permission command received at the permission-command-reception step with the permission list in association with each other;
receiving the job transmitted from the client apparatus identified by the client-identification information managed on the permission list;
executing print processing based on the job received at the job-reception step; and
cancelling the permission after the print processing is executed based on the job at the print step by deleting the job-identification information of the job for which the print processing executed and the client-identification information managed in correspondence with the job-identification information, where the job-identification information and the client-identification information are shown on the permission list.

13. The information-processing method according to claim 12, further comprising:
receiving communication data including client-identification information provided to establish a connection used to transmit the job from the client apparatus to the image-forming apparatus;
determining whether the client-identification information included in the communication data received at the communication-data-reception step is managed on the permission list; and
giving no response to the communication data when it is determined that the client-identification information included in the communication data is not managed on the permission list at the determining step and giving a response to the communication data for the client apparatus, the communication data being provided to establish the connection for transmitting the job between the client apparatus and the image-forming apparatus, when it is determined that the client-identification information included in the communication data is managed on the permission list at the determining step, and
wherein, at the job-reception step, the job is received after the connection is established for transmitting the job between the client apparatus and the image-forming apparatus in accordance with a result of the response given at the response step.

14. A computer-readable storage medium storing a program, the program storing instructions to achieve the information-processing method according to claim 12.
